(19) United States
(12) Patent Application Publication
(10) Pub. No.: US 2015/0002295 A1
(43) Pub. Date: Jan. 1, 2015

(54) LOCATABLE REMOTE CONTROL AND ASSOCIATED CONTENT CONSUMPTION DEVICES

(71) Applicants: Brian J. Thurmon, Chandler, AZ (US); Edward O. Clapper, Tempe, AZ (US)

(72) Inventors: Brian J. Thurmon, Chandler, AZ (US); Edward O. Clapper, Tempe, AZ (US)

(21) Appl. No.: 13/928,731

(22) Filed: Jun. 27, 2013

(51) Int. Cl. G08B 21/24

(52) U.S. Cl. CPC G08B 21/24
USPC 340/539.32

(57) ABSTRACT

Apparatuses, methods and storage medium associated with content consumption are disclosed herein. In embodiments, an apparatus may include a presentation engine configured to receive and present content on a display unit. The apparatus may further include a user interface engine configured to receive user commands to control operation of the apparatus, including a user command to locate a remote control associated with control of the apparatus. The user interface engine may be further configured to locate the remote control, and provide visual or audio cues about a location of the remote control, in response to receipt of the user command to locate the remote control. Other embodiments may be described and/or claimed.

### TECHNICAL FIELD

The present disclosure relates to the field of content consumption, in particular, to apparatuses, methods and storage medium associated with locatable remote controls, and associated content consumption devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and the manners the contents are consumed. Today, multi-media contents may be available from fixed medium (e.g., Digital Versatile Disk (DVD)), broadcast, cable operators, satellite channels, Internet, and so forth. User may consume contents with a television set, a laptop or desktop computer, a tablet, a smartphone, or other stationary or mobile devices of the like. In addition to the contents themselves, ease of consumption remains an important factor to the overall user experience and satisfaction.

Content consumption devices are often controlled with remote controls. Users often misplace the remote controls. Locating a misplaced remote control is often a frustrating experience for the user.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption, in accordance with various embodiments.

FIG. 2 illustrates examples of visual indication of a location of a remote control, in accordance with various embodiments.

FIG. 3 illustrates an example remote control, in accordance with various embodiments.

FIG. 4 illustrates an example process for locating a remote control, in accordance with various embodiments;

FIG. 5 illustrates an example computing environment suitable for practicing the disclosure, in accordance with various embodiments.

FIG. 6 illustrates an example storage medium with instructions configured to enable an apparatus to practice the present disclosure, in accordance with various embodiments.

### DETAILED DESCRIPTION

Apparatuses, methods and storage medium associated with content consumption are disclosed herein. In embodiments, an apparatus, e.g., a set-top box, may include a presentation engine configured to receive and present content on a display unit, e.g., a television set. The apparatus may further include a user interface engine configured to receive user commands to control operation of the apparatus, including a user command to locate a remote control associated with control of the apparatus. The user interface engine may be further configured to locate the remote control, and provide visual or audio cues about location of the remote control, in response to receipt of the user command to locate the remote control.

In embodiments, a remote control may include one or more communication interfaces, and a controller configured to cause the one or more communication interfaces to transmit control commands to a content consumption device, e.g., a smart TV, to control receipt and presentation of content on the content consumption device. The controller may be further configured to cause the one or more communication interfaces to respond with electro-magnetic, electro-mechanical, optical or acoustic signals to a signal from the content consumption device requesting responsive signals to assist in locating the remote control.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

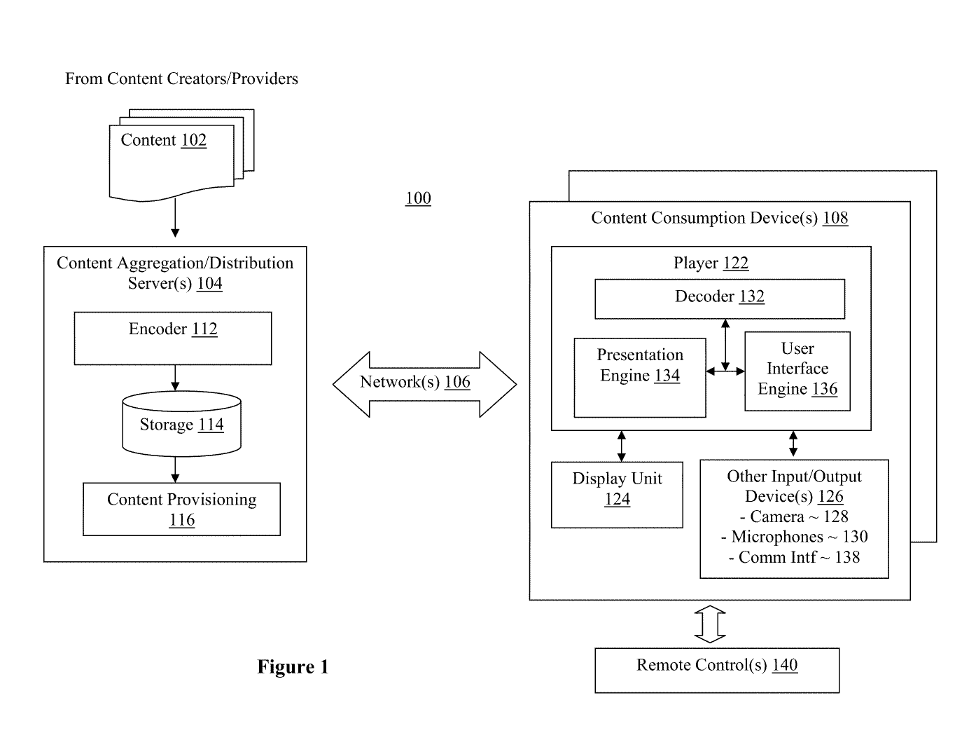

Referring now to FIG. 1, wherein an arrangement for content distribution and consumption, in accordance with various embodiments, is illustrated. As shown, in embodiments, arrangement 100 for distribution and consumption of content may include a number of content consumption device(s) 108 coupled with one or more content aggregation/distribution servers 104 via one or more networks 106. In embodiments, content consumption device(s) 108 may be controlled by respective ones of remote control(s) 140. Further, content consumption device(s) 108 and remote control(s) 140 may be incorporated with teaching of the present disclosure to facilitate locating remote control(s) 140, in the event they are misplaced, These and other aspects will be described more fully below, after further description of arrangement 100.

Content aggregation/distribution servers 104 may be configured to aggregate and distribute contents to content consumption device(s) 108 for consumption, via one or more networks 106. In embodiments, as shown, content aggregation/distribution servers 104 may include encoder 112, storage 114 and content provisioning 116, coupled to each other. Encoder 112 may be configured to encode contents 102 from various content providers, and storage 114 may be configured to store encoded content. Content provisioning 116 may be configured to selectively retrieve and stream encoded content to the various content consumption device(s) 108 in response to requests from the various content consumption device(s) 108.

Contents 102 may be multi-media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In embodiments, for efficiency of operation, encoder 112 may be configured to transcode the various contents 102, typically in different encoding formats, into a subset of one or more common encoding formats. However, encoder 112 may be configured to nonetheless maintain indices or cross-references to the corresponding contents in their original encoding formats. Similarly, for flexibility of operation, encoder 112 may transcode or otherwise process each or selected ones of contents 102 into multiple versions of different quality levels. The different versions may provide different resolutions, and/or require different bit rates and/or frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video and/or audio data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning 116 may, in various embodiments, be configured to provide encoded content as discrete files and/or as continuous streams of encoded content. Content provisioning 116 may be configured to transmit the compressed audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

Continuing to refer to FIG. 1, networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which servers 104 go through to communicate with content consumption device(s) 108. Similarly, at the content consumption end, networks 106 may include base stations and/or access points, through which consumption devices 108 communicate with servers 104. In between the two ends may be any number of network routers, switches and other networking equipment of the like. However, for ease of understanding, these gateways, firewalls, routers, switches, base stations, access points and the like are not shown.

In embodiments, as shown, a content consumption device(s) 108 may include player 122, display unit 124 and other user input/output device(s) 126. Player 122 may be configured to receive streamed content, decode and recovered the content from the content stream, and present the recovered content on display unit 124, in response to user selections/inputs from other user input/output devices 126. Player 122 may be configured to adapt the presentation of a content to enhance user experience during response to some user commands, where the adaptation is in addition to a nominal response to the user commands. For example, in embodiments, player 122 may be configured to adapt the presentation of a content to enhance user experience, including support for responding to a user command to skip secondary content during presentation. The responsive skipping may be in accordance with the associated policies, such as the illustrative policies described earlier and other policies of the like.

In embodiments, on the content consumption device side, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. User interface engine 136 may be configured to receive the user selections/inputs from a user.

Further, in various embodiments, decoder 132, presentation engine 136, and user interface engine 136, combinations or sub-combinations thereof, may be configured to effectuate for player 122 the earlier described adaptation of the presentation of a content to enhance user experience during response to some user commands, where the adaptation is in addition to a nominal response to the user commands. See e.g. U.S. patent application Ser. No. 13/727,138, entitled “CONTENT PRESENTATION WITH ENHANCED USER EXPERIENCE,” filed Dec. 26, 2012. Similarly, decoder 132, presentation engine 134, and user interface engine 136, combinations or sub-combinations thereof, may also be configured to effectuate for player 122 the earlier described partial response to one or more other user commands in view of one or more rules associated with presentation of the content to enhance user experience. In embodiments, decoder 132 may be configured to receive and process the associated policies governing skipping of secondary content, separate from the receipt and decoding of the stream of content. In other embodiments, decoder 132 may be configured to extract the associated policies from the stream of content. Presentation engine 134 may be configured with all or the bulk of logic for responding to a skip secondary content command, in accordance with the associated policies. User interface engine 136 may be configured to receive and forward the skip secondary content commands. See e.g. U.S. patent application Ser. No. 13/790,176, entitled “CONTENT PRESENTATION WITH SECONDARY CONTENT SKIP,” filed Mar. 8, 2013.

While shown as part of a content consumption device(s) 108, display unit 124 and/or other input/output device(s) 126 may be standalone devices or integrated, for different embodiments of content consumption device(s) 108. For example, for a television arrangement, display 124 may be a stand-alone television set, Liquid Crystal Display (LCD), Plasma and the like, while player 122 may be part of a separate set-top set, and other user input/output device(s) may be a separate keyboard. Similarly, for a desktop computer arrangement, player 122, display unit 124 and other input/output device(s) 126 may all be separate stand alone units. On the other hand, for a laptop, ultrabook, tablet or smartphone arrangement, player 122, display unit 124 and other input/output devices 126 may be integrated together into a single form factor. Further, for tablet or smartphone arrangement, a touch sensitive display screen may also server as one of the other user input/output device(s) 126, and player 122 may be a computing platform with a soft keyboard that also include one of the other user input/output device(s) 126.

In embodiments, as shown, other user input/output device(s) 126 may include camera 128, microphones 130 and communication interface 132. Camera 128 may be configured to capture images, in particular, images of the surroundings of content consumption device 108. As will be described in more detail below, in embodiments, camera 128 may be used to capture optical responses of remote control(s) 140 to enable remote control(s) 140 to be located. Microphones 130 may include a microphone configured to accept audio input from the user, including, in embodiments, a voice command to locate remote control(s) 140. As will be described in more detail below, in embodiments, microphones 130 may include a microphone array configured to capture acoustic responses of remote control(s) 140 to enable remote control(s) 140 to be located. Communication interfaces 138 may include a wireless communication interface, e.g., a Bluetooth® communication interface, configured to transmit and receive wireless electro-magnetic signals. In embodiments, a button (not shown) may be provided, in addition to, or in lieu of microphones 130 to enable a user to tactilely provide a command to locate remote control(s) 140. The button may be conveniently located with other controls of content consumption device(s) 108. As will be described in more detail below, in embodiments, the wireless communication interface may be used to capture electro-magnetic responses of remote control(s) 140 to enable remote control(s) 140 to be located. In embodiments, communication interfaces 138 may also include an infrared communication interface configured to receive commands encoded in infrared signals from remote control(s) 140.

As will be described in more detail below, on locating remote control(s) 140, the location of remote control may be visually or aurally conveyed to the user. Before further describing these details, it should be noted that while for ease of understanding, the present disclosure will be described with content consumption device 108 having player 122 with decoder 132 and presentation engine 134, configured to receive, decode, and present streamed content, the present disclosure is not so limited. In embodiments, the present disclosure may be practiced with a wide range of content consumption device(s) 108 including, but are not limited to, content consumption device(s) 108 configured with presentation engine 134 equipped for presenting conventional broadcast content.

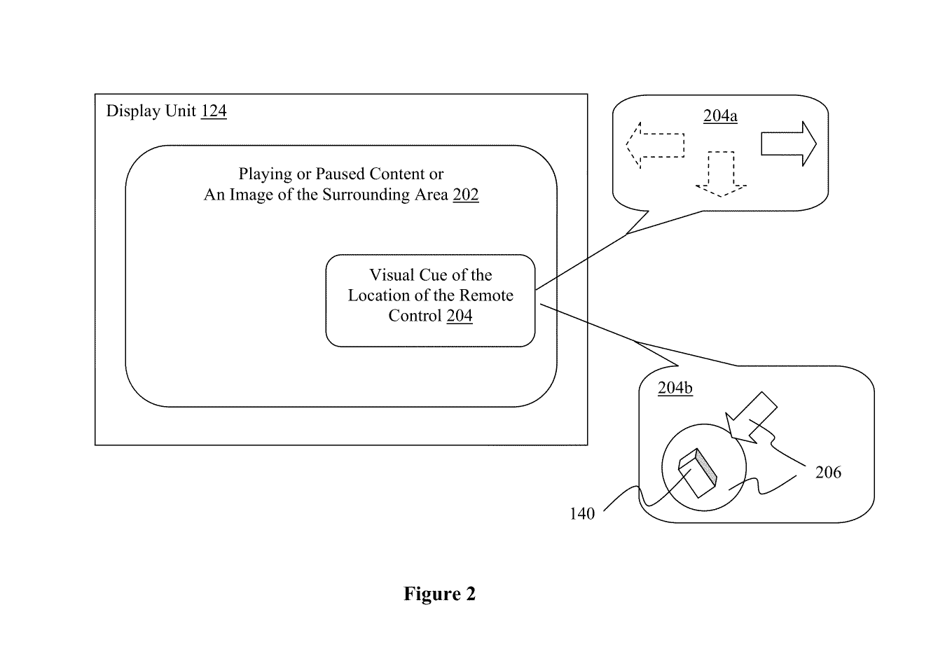

Referring now FIG. 2, wherein examples of visual cue of a location of a remote control, in accordance with various embodiments, are shown. As illustrated, on locating the remote control, visual cues of the location of the remote control may be conveyed to the user through visual cue 204 rendered on display unit 124. Visual cue 204 may be superimposed on the content being rendered or with the content paused 202. In embodiments, visual cue 204 may be superimposed on an image 202 of the surroundings of the content consumption device(s) 108. Image 202 of the surroundings of the content consumption device(s) 108 may be an image of the portion of the surroundings where remote control(s) 140 is located, e.g., an image of the left side of the living room where the TV content consumption device(s) 108 is located.

In different embodiments, visual cue 204 may vary in its sophistication. In embodiments, visual cue 204 may be basic 204a or more sophisticated 204b cues, or something in between. An example basic visual cue 204a may include a number of directional arrows selectively lighted or otherwise highlighted (denoted by solid lines, as opposed to dash lines) to generally signal to the user where remote control(s) 140 is located. An example more sophisticated 204b visual cue, used in conjunction with an image 202 of a portion of the surroundings where remote control(s) 140 is located, may include features 206 that highlight remote control(s) 140 in image 202.

Similarly, aural cue may be basic or more sophisticated, or something in between. An example basic aural cue may include content consumption device(s) 108 outputting an audio message like “remote control is in the right side of the room.” An example more sophisticated aural cue, used in conjunction with recognition of objects in an image 202 of a portion of the surroundings where remote control(s) 140 is located, may include content consumption device(s) 108 outputting a more precise audio message like “remote control is on the sofa.” The optional object recognition may be accomplished using a wide range of object recognition techniques. Aural cues may be provided with audio of the content being rendered paused.

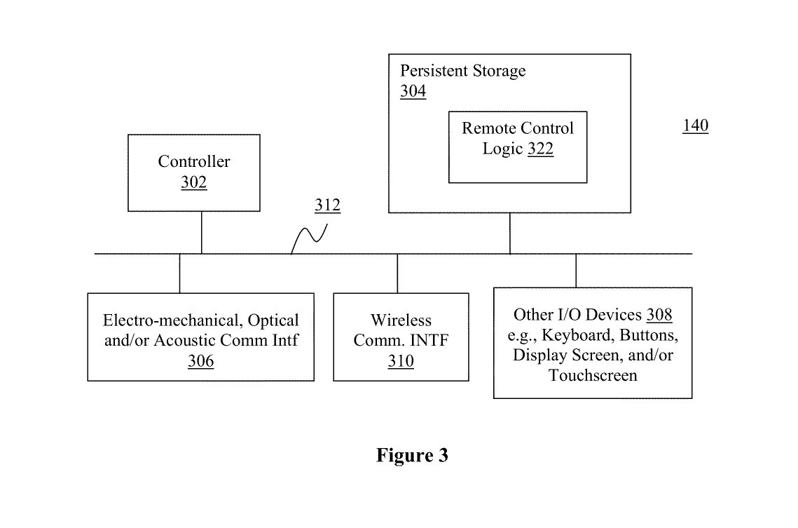

FIG. 3 illustrates an example remote control, in accordance with various embodiments. As shown, remote control(s) 140 may include one or more controllers 302, and persistent storage 304. Controllers 302 may include one or more processor or processor cores. For the purpose of this application, including the claims, the terms “processor” and “processor cores” may be considered synonymous, unless the context clearly requires otherwise.

Additionally, remote control(s) 140 may include electro-mechanical, optical and/or acoustic communication interface(s) 306, and wireless electro-magnetic communication interface(s) 310. Electro-mechanical communication interface(s) may include, e.g., vibrators, configured to provide vibration responses to assist in locating remote control 140, when misplaced. Optical communication interface(s) 306 may include, e.g., light emitting diodes (LED), and configured to provide optical responses to assist in locating remote control 140, when misplaced. Similarly, acoustic communication interface(s) 306 may be configured to provide acoustic responses, audible or non-audible, to assist in locating remote control 140, when misplaced. Wireless electro-magnetic communication interface(s) 308 may be configured to transmit and receive electro-magnetic signals, including transmission of electro-magnetic signals to assist in locating remote control 140, when misplaced. An example of wireless electro-magnetic communication interface(s) 308 may include a Bluetooth® communication interface.

Further, in embodiments, remote control(s) 140 may include other input/output devices 308, such as, but not limited, display (touch sensitive or otherwise), keyboard, cursor control, buttons, and so forth. These and the earlier described elements may be coupled to each other via system bus 312, which may represent one or more buses. In the case of multiple buses, they may be bridged by one or more bus bridges (not shown).

Persistent storage 304 may be employed to store a working/permanent copy of the programming instructions implementing the operations associated with remote control(s) 140. The programming instructions may be assembler instructions supported by the processor(s) of controller 302 or high-level languages, such as, for example, C, that can be compiled into such instructions. The programming instructions may be placed into persistent storage 304 in the factory, or in the field, through, for example, content consumption device(s) 108.

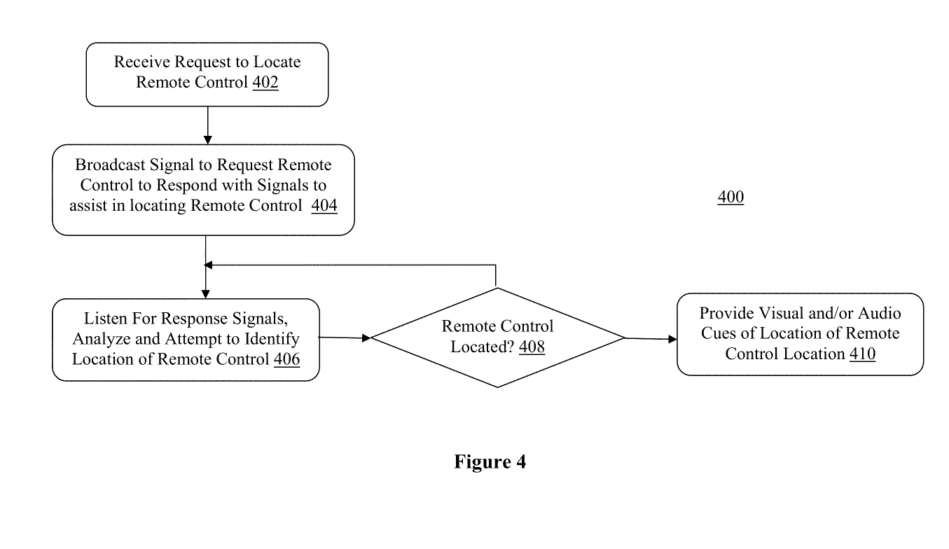

FIG. 4 illustrates an example process for locating a remote control, in accordance with various embodiments. Process 400 for locating a remote control may be practiced, e.g., by content consumption device(s) 108, with the cooperation of remote control(s) 140. As shown, process 400 may start at block 402. At block 402, a command to locate remote control(s) 140 may be received, e.g., by content consumption device(s) 108. The command may be received, e.g., audibly or tactilely, from the user.

From block 402, process 400 may proceed to block 404. At block 404, a signal may be broadcast, e.g., by content consumption device(s) 108, to request remote control(s) 140 to respond with signals to enable remote control(s) 140 to be located. The request signal may, e.g., be an electro-magnetic broadcast signal, such as, but not limited to, an electro-magnetic broadcast signal broadcast in accordance with the Bluetooth® communication protocol.

From block 404, process 400 may proceed to blocks 406 and 408. At block 406, a listen and analyze operation made be performed, e.g., by content consumption device(s) 108, to detect for the responsive signals provided by remote control(s) 140, and analyze the detected responsive signals to attempt to identify a location of remote control(s) 140. In embodiments, the responsive signals may be electro-magnetic, electro-mechanical, optical and/or acoustic signals. Thus, the listen and analyze operation may include the employment of an array of wireless electro-magnetic/mechanical communication interfaces to receive the electro-magnetic/mechanical responsive signals, and analyze the received responsive signals to determine the source direction of the electro-magnetic/mechanical responsive signals, thereby, determining or contributing to the determining of the location of remote control(s) 140. Additionally, the listen and analyze operation may include the employment of camera 120 to take a number of images of the surroundings of content consumption device(s) 108 to capture the optical responsive signals, and analyze the images to determine the source direction of the optical responsive signals, thereby, determining the location of remote control(s) 140. Further the listen and analyze operation may include the employment of an array of microphones to receive the acoustic responsive signals, and analyze the received responsive signals to determine the source direction of the acoustic responsive signals, thereby, determining or contributing to the determining of the location of remote control(s) 140.

At block 408, a determination may be made on whether the listen and analyze operations are able to determine the location of remote control(s) 140. If the listen and analyze operations are not able to determine the location of remote control(s) 140, the listen and analyze operations of block 406 may be continued. If the listen and analyze operations are able to determine the location of remote control(s) 140, process 400 may proceed to block 410.

At block 410, process 400 may provide, e.g., by content consumption device(s) 108, visual and/or audio cues for the location of remote control(s) 140. As described earlier, visual cues may include simple or more sophisticated visual cues about the location of remote control(s) 140 overlaying the content being rendered or paused, or overlaying an image of the surroundings. Similarly, audio cues may include simple or more sophisticated audio announcements about the location of remote control(s) 140.

Back at blocks 406 and 408, the listen and analyze operations may continue for a customizable time period, and terminate, if the operations remain unable to determine a possible location of remote control(s) 140. On termination, process 400 may provide, e.g., by content consumption device(s) 108, visual or audio feedback, on the inability to locate remote control(s) 140.

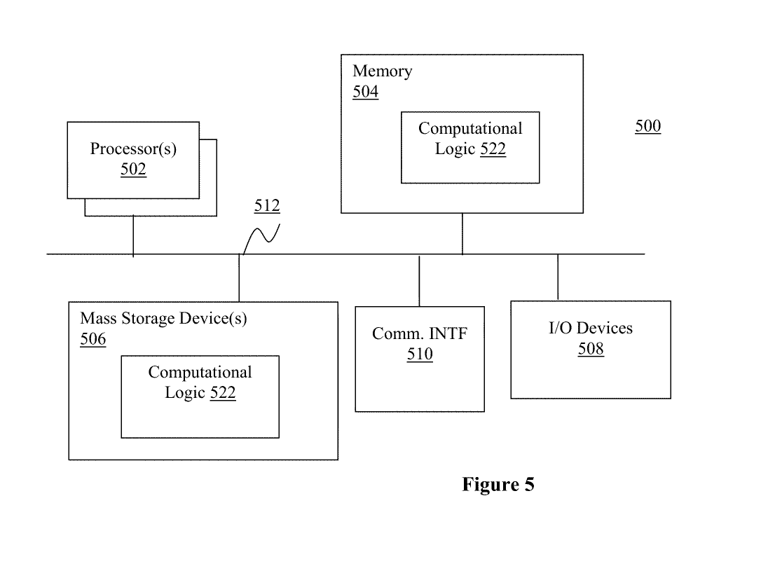

Referring now to FIG. 5, wherein an example computer suitable for use for the arrangement of FIG. 1, in accordance with various embodiments, is illustrated. As shown, computer 500 may include one or more processor(s) or processor cores 502, and system memory 504. For the purpose of this application, including the claims, the terms “processor” and “processor cores” may be considered synonymous, unless the context clearly requires otherwise. Additionally, computer 500 may include mass storage device(s) 506 (such as diskette, hard drive, compact disc read only memory (CD-ROM) and so forth), input/output devices 508 (such as display, keyboard, cursor control and so forth) and communication interfaces 510 (such as network interface cards, modems and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage device(s) 506 may be employed to store a working copy and a permanent copy of the programming instructions implementing the operations associated with content aggregation/distribution servers 104 or content consumption device(s) 108, earlier described. The various elements may be implemented by assembler instructions supported by processor(s) 502 or high-level languages, such as, for example, C, that can be compiled into such instructions.

The permanent copy of the programming instructions may be placed into permanent storage device(s) 506 in the factory, or in the field, through, for example, a distribution medium (not shown), such as a compact disc (CD), or through communication interface 510 (from a distribution server (not shown)). That is, one or more distribution media having an implementation of the agent program may be employed to distribute the agent and program various computing devices.

The number, capability and/or capacity of these elements 510-512 may vary, depending on whether computer 500 is used as a content aggregation/distribution server 104 or a content consumption device(s) 108. When use as content consumption device, whether the content consumption device is a stationary or mobile device, like a smartphone, computing tablet, ultrabook or laptop. Their constitutions are otherwise known, and accordingly will not be further described.

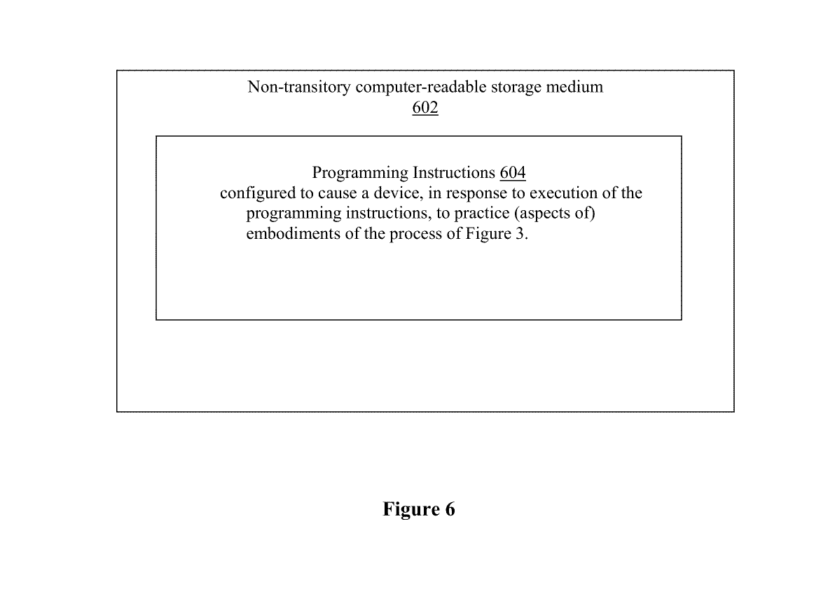

FIG. 6 illustrates an example non-transitory computer-readable storage medium having instructions configured to practice all or selected ones of the operations associated with content aggregation/distribution servers 104 or content consumption device(s) 108, earlier described; in accordance with various embodiments. As illustrated, non-transitory computer-readable storage medium 602 may include a number of programming instructions 604. Programming instructions 604 may be configured to enable a device, e.g., computer 600, in response to execution of the programming instructions, to perform, e.g., various operations of process 140 of FIG. 3, e.g., but not limited to, the operations performed in association with responding to a skip secondary content command during presentation in accordance with associated policies of the secondary content. In alternate embodiments, programming instructions 604 may be disposed on multiple non-transitory computer-readable storage media 602 instead.

Referring back to FIG. 5, for one embodiment, at least one of processors 502 may be packaged together with computational logic 522 (in lieu of storing on memory 504 and storage 506) configured to practice aspects of the process of FIG. 4. For one embodiment, at least one of processors 502 may be packaged together with computational logic 522 configured to practice aspects of the process of FIG. 4 to form a System in Package (SiP). For one embodiment, at least one of processor(s) 502 may be integrated on the same die with computational logic 522 configured to practice aspects of the process of FIG. 4. For one embodiment, at least one of processor(s) 502 may be packaged together with computational logic 522 configured to practice aspects of the process of FIG. 4 to form a System on Chip (SoC). For at least one embodiment, the SoC may be utilized in, e.g., but not limited to, a computing tablet.

Thus various example embodiments of the present disclosure have been described including, but are not limited to:

Example 1 which may be an apparatus for consuming content. The apparatus may include a presentation engine and an user interface engine. The presentation engine may be configured to present the content on a display unit. The user interface engine may be coupled with the presentation engine, and configured to receive user commands to control operation of the apparatus, including a user command to locate a remote control associated with control of the apparatus, wherein the user interface engine is further configured to locate the remote control, and provide visual or audio cues about location of the remote control, in response to receipt of the user command to locate the remote control.

Example 2 may be example 1, further including a microphone arrangement coupled with the user interface engine, wherein the microphone arrangement includes at least one microphone configured to enable the user command to locate the remote control to be provided orally to the user interface engine.

Example 3 may be any one of examples 1-2, further including a button coupled with the user interface engine to enable the user command to locate the remote control to be provided tactilely to the user interface engine.

Example 4 may be any one of examples 1-3, further including an electro-magnetic wireless communication interface coupled with the user interface engine, wherein the user interface engine is configured to transmit, in response to the user command to locate the remote control, via the wireless communication interface, an electro-magnetic signal to activate the remote control, and cause the remote control to respond with electro-magnetic, electro-mechanical, optical or acoustic signals, to enable the user interface engine to locate the remote control.

Example 5 may be example 4, wherein the remote control responds electro-magnetically, and the user interface engine is further configured to receive the electro-magnetic response signals through the electro-magnetic wireless communication interface, analyze the electro-magnetic response signals, and identify a location of the remote control.

Example 6 may be example 4, wherein the remote control responds optically; wherein the apparatus further comprises a camera configured to capture images of a surroundings of the apparatus; and wherein the user interface engine is further coupled with the camera, and configured to analyze optical responses of the remote control captured by the camera, and identify a location of the remote control.

Example 7 may be example 4, wherein the remote control responds acoustically; wherein the apparatus further comprises a microphone arrangement configured to receive the acoustic responses; and wherein the user interface engine is further coupled with the microphone arrangement, and configured to analyze the acoustic responses of the remote control captured by the microphone arrangement, and identify a location of the remote control.

Example 8 may be any one of examples 1-7, wherein the user interface engine is configured to provide visual cues about the location of the remote control, overlaying the content being presented onto the display unit or paused.

Example 9 may be any one of examples 1-8, further comprising a camera configured to capture images of a surroundings of the apparatus, and wherein the user interface engine is configured to provide visual cues about the location of the remote control, overlaying an image of the surroundings captured by the camera and rendered on the display unit.

Example 10 may be any one of examples 1-9, wherein the user interface engine is configured to provide audio cues about the location of the remote control, pausing presentation of the content.

Example 11 may be any one of examples 1-10, wherein the apparatus is a selected one of a smartphone, a personal digital assistant, a computing tablet, an ultrabook, a laptop computer, a game console, a set-top box, or a television set.

Example 12 may be one or more storage medium having a plurality of instructions configured to cause a content consumption device, in response to execution of the instructions by the content consumption device, to perform a number of actions. The actions may include receive and present content; and receive user commands to control the receive and present, including receipt of a user command to locate a remote control associated with control of the receive and present. The action may further include, in response to receipt of the user command to locate the remote control, locate the remote control, and provide visual or audio cues about a location of the remote control.

Example 13 may be example 12, wherein receive a user command to locate a remote control comprises receive the user command, by the content consumption device, via a microphone of the content consumption device, the user command being orally provided to the content consumption device.

Example 14 may be example 12, wherein receive a user command to locate a remote control comprises receive the user command, by the content consumption device, via a button of the content consumption device, the user command being tactilely provided to the content consumption device.

Example 15 may be any one of examples 12-14, wherein the instructions, in response to execution, further cause the content consumption device to transmit, in response to the user command to locate the remote control, an electro-magnetic signal to activate the remote control, to cause the remote control to respond with electro-magnetic, electro-mechanical, optical or acoustic signals, and to analyze the electro-magnetic, electro-mechanical, optical or acoustic signals to identify a location of the remote control.

Example 16 may be any one of examples 12-15, wherein the instructions, in response to execution, further cause the content consumption device to provide visual cues about the location of the remote control, overlaying the content being presented or paused, or overlaying an image of a surroundings the content consumption device; or providing audio cues about the location of the remote control, pausing presentation of the content.

Example 17 may be a method for consuming content. The method may include receiving and presenting, by a content consumption device, the content; and receiving, by the content consumption device, user commands to control the receiving and presenting, including receiving a user command to locate a remote control associated with controlling the receiving and presenting. The method may further include in response to receipt of the user command to locate the remote control, locating, by the content consumption device, the remote control, and providing visual or audio cues about location of the remote control.

Example 18 may be example 17, wherein locating the remote control includes transmitting, in response to the user command to locate the remote control, by the content consumption device, an electro-magnetic signal to activate the remote control, to cause the remote control to respond with electro-magnetic, electro-mechanical, optical or acoustic signals; and analyzing the electro-magnetic, electro-mechanical, optical or acoustic signals to locate the remote control.

Example 19 may be an apparatus for controlling a content consumption device. The apparatus may include one or more communication interfaces; and a controller. The controller may be coupled to the one or more communication interfaces, and configured to cause the one or more communication interfaces to transmit control commands to the content consumption device to control receipt and presentation of content on the content consumption device, wherein the controller is further configured to cause the one or more communication interfaces to respond with electro-magnetic, electro-mechanical, optical or acoustic signals to enable the content consumption device to locate the apparatus, in response to a signal from the content consumption device.

Example 20 may be example 19, wherein the one or more communication interfaces comprises a wireless communication interface coupled with the controller to wirelessly receive the signal from the content consumption device that requests the apparatus to respond with the electro-magnetic, electro-mechanical, optical or acoustic signals, and forward the wirelessly received signal to the controller; and an optical communication interface coupled to the controller and configured to respond with the optical signals under control of the controller.

Example 21 may be example 19, wherein the one or more communication interfaces comprises a wireless communication interface coupled with the controller to wirelessly receive the signal from the content consumption device that requests the apparatus t to respond with the electro-magnetic, electro-mechanical, optical or acoustic signals, and forward the wirelessly received signal to the controller; and an acoustic communication interface coupled to the controller and configured to respond with the acoustic signals under control of the controller.

Example 22 may be one or more storage medium having a plurality of instructions configured to cause a remote control, in response to execution of the instructions by the remote control, to perform a number of actions. The actions may include transmit control commands to a content consumption device to control receipt and presentation of content on the content consumption device; and respond with electro-magnetic, electro-mechanical, optical or acoustic signals to a signal from the content consumption device that requests responsive signals from the remote control to enable the remote control to be located.

Example 23 may be example 22, wherein the instructions are further configured to cause the remote control, in response to execution of the instruction, to wirelessly receive the signal from the content consumption device that requests responsive signals from the remote control to enable the remote control to be located; and in response, control an optical communication interface to respond with the optical signals.

Example 24 may be example 22, wherein the instructions are further configured to cause the remote control, in response to execution of the instruction, to wirelessly receive the signal from the content consumption device that requests responsive signals from the remote control to enable the remote control to be located; and in response, control an acoustic communication interface to respond with the acoustic signals.

Example 25 may be a method for controlling consuming content. The method may include transmitting, by a remote control, control commands to a content consumption device to control receipt and presentation of a content on the content consumption device; and receiving, by the remote control, from the content consumption device, a signal from the content consumption device, requesting response signals from the remote control to enable the remote control to be located. The method may further include responding, by the remote control, with electro-magnetic, electrical mechanical, optical or acoustic signals to enable the remote control to be located.

Example 26 may be example 25, wherein responding with acoustic signals comprises responding with acoustic signals with a frequency that lies outside a human hearing frequency range.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for consuming content, comprising:
a presentation engine configured to present the content on a display unit; and
a user interface engine coupled with the presentation engine, and configured to receive user commands to control operation of the apparatus, including a user command to locate a remote control associated with control of the apparatus, wherein the user interface engine is further configured to locate the remote control, and provide visual or audio cues about location of the remote control, in response to receipt of the user command to locate the remote control.

2. The apparatus of claim 1, further comprising a microphone arrangement coupled with the user interface engine, wherein the microphone arrangement includes at least one microphone configured to enable the user command to locate the remote control to be provided orally to the user interface engine.

3. The apparatus of claim 1, further comprising a button coupled with the user interface engine to enable the user command to locate the remote control to be provided tactilely to the user interface engine.

4. The apparatus of claim 1, further comprising an electro-magnetic wireless communication interface coupled with the user interface engine, wherein the user interface engine is configured to transmit, in response to the user command to locate the remote control, via the wireless communication interface, an electro-magnetic signal to activate the remote control, and cause the remote control to respond with electro-magnetic, electro-mechanical, optical or acoustic signals, to enable the user interface engine to locate the remote control.

5. The apparatus of claim 4, wherein the remote control responds electro-magnetically, and the user interface engine is further configured to receive the electro-magnetic response signals through the electro-magnetic wireless communication interface, analyze the electro-magnetic response signals, and identify a location of the remote control.

6. The apparatus of claim 4, wherein the remote control responds optically; wherein the apparatus further comprises a camera configured to capture images of a surroundings of the apparatus; and wherein the user interface engine is further coupled with the camera, and configured to analyze optical responses of the remote control captured by the camera, and identify a location of the remote control.

7. The apparatus of claim 4, wherein the remote control responds acoustically; wherein the apparatus further comprises a microphone arrangement configured to receive the acoustic responses; and wherein the user interface engine is further coupled with the microphone arrangement, and configured to analyze the acoustic responses of the remote control captured by the microphone arrangement, and identify a location of the remote control.

8. The apparatus of claim 1, wherein the user interface engine is configured to provide visual cues about the location of the remote control, overlaying the content being presented onto the display unit or paused.

9. The apparatus of claim 1, further comprising a camera configured to capture images of surroundings of the apparatus, and wherein the user interface engine is configured to provide visual cues about the location of the remote control, overlaying an image of the surroundings captured by the camera and rendered on the display unit.

10. The apparatus of claim 1, wherein the user interface engine is configured to provide audio cues about the location of the remote control, pausing presentation of the content.

11. The apparatus of claim 1, wherein the apparatus is a selected one of a smartphone, a personal digital assistant, a computing tablet, an ultrabook, a laptop computer, a game console, a set-top box, or a television set.

12. At least one storage medium comprising a plurality of instructions configured to cause a content consumption device, in response to execution of the instructions by the content consumption device, to:
receive and present content;
receive user commands to control the receive and present, including receipt of a user command to locate a remote control associated with control of the receive and present; and
in response to receipt of the user command to locate the remote control, locate the remote control, and provide visual or audio cues about a location of the remote control.

13. The at least one storage medium of claim 12, wherein receive a user command to locate a remote control comprises receive the user command, by the content consumption device, via a microphone of the content consumption device, the user command being orally provided to the content consumption device.

14. The at least one storage medium of claim 12, wherein receive a user command to locate a remote control comprises receive the user command, by the content consumption device, via a button of the content consumption device, the user command being tactilely provided to the content consumption device.

15. The at least one storage medium of claim 12, wherein the instructions, in response to execution, further cause the content consumption device to transmit, in response to the user command to locate the remote control, an electro-magnetic signal to activate the remote control, to cause the remote control to respond with electro-magnetic, electro-mechanical, optical or acoustic signals, and to analyze the electro-magnetic, electro-mechanical, optical or acoustic signals to identify a location of the remote control.

16. The at least one storage medium of claim 12, wherein the instructions, in response to execution, further cause the content consumption device to provide visual cues about the location of the remote control, overlaying the content being presented or paused, or overlaying an image of surroundings the content consumption device; or providing audio cues about the location of the remote control, pausing presentation of the content.

17. A method for consuming content, comprising:
receiving and presenting, by a content consumption device, the content; and
receiving, by the content consumption device, user commands to control the receiving and presenting, including receiving a user command to locate a remote control associated with controlling the receiving and presenting; and
in response to receipt of the user command to locate the remote control, locating, by the content consumption device, the remote control, and providing visual or audio cues about location of the remote control.

18. The method of claim 17, wherein locating the remote control comprises:
transmitting, in response to the user command to locate the remote control, by the content consumption device, an electro-magnetic signal to activate the remote control, to cause the remote control to respond with electro-magnetic, electro-mechanical, optical or acoustic signals; and
analyzing the electro-magnetic, electro-mechanical, optical or acoustic signals to locate the remote control.

19. An apparatus for controlling a content consumption device, the apparatus comprising:
one or more communication interfaces; and
a controller coupled to the one or more communication interfaces, and configured to cause the one or more communication interfaces to transmit control commands to the content consumption device to control receipt and presentation of content on the content consumption device, wherein the controller is further configured to cause the one or more communication interfaces to respond with electro-magnetic, electro-mechanical, optical or acoustic signals to enable the content consumption device to locate the apparatus, in response to a signal from the content consumption device.

20. The apparatus of claim 19, wherein the one or more communication interfaces comprises a wireless communication interface coupled with the controller to wirelessly receive the signal from the content consumption device that requests the apparatus to respond with the electro-magnetic, electro-mechanical, optical or acoustic signals, and forward the wirelessly received signal to the controller; and
an optical communication interface coupled to the controller and configured to respond with the optical signals under control of the controller.

21. The apparatus of claim 19, wherein the one or more communication interfaces comprises a wireless communication interface coupled with the controller to wirelessly receive the signal from the content consumption device that requests the apparatus t to respond with the electro-magnetic, electro-mechanical, optical or acoustic signals, and forward the wirelessly received signal to the controller; and
an acoustic communication interface coupled to the controller and configured to respond with the acoustic signals under control of the controller.

22. At least one storage medium comprising a plurality of instructions configured to cause a remote control, in response to execution of the instructions by the remote control, to:
transmit control commands to a content consumption device to control receipt and presentation of content on the content consumption device; and
respond with electro-magnetic, electro-mechanical, optical or acoustic signals to a signal from the content consumption device that requests responsive signals from the remote control to enable the remote control to be located.

23. The at least one storage medium of claim 22, wherein the instructions are further configured to cause the remote control, in response to execution of the instruction, to wirelessly receive the signal from the content consumption device that requests responsive signals from the remote control to enable the remote control to be located; and in response, control an optical communication interface to respond with the optical signals.

24. The at least one storage medium of claim 22, wherein the instructions are further configured to cause the remote control, in response to execution of the instruction, to wirelessly receive the signal from the content consumption device that requests responsive signals from the remote control to enable the remote control to be located; and in response, control an acoustic communication interface to respond with the acoustic signals.

25. A method for controlling consuming content, the method comprising:
transmitting, by a remote control, control commands to a content consumption device to control receipt and presentation of a content on the content consumption device,
receiving, by the remote control, from the content consumption device, a signal from the content consumption device, requesting response signals from the remote control to enable the remote control to be located; and
responding, by the remote control, with electro-magnetic, electro-mechanical, optical or acoustic signals to enable the remote control to be located.

26. The method of claim 25, wherein responding with acoustic signals comprises responding with acoustic signals with a frequency that lies outside a human hearing frequency range.
